(19) United States
(12) Patent Application Publication
(10) Pub. No.: US 2014/0215319 A1
(43) Pub. Date: Jul. 31, 2014

(54) PRODUCT SPECIFICATION GENERATION

(71) Applicant: David Otey, Montgomery, IL (US)

(72) Inventor: David Otey, Montgomery, IL (US)

(73) Assignee: SIEMENS INDUSTRY, INC., Alpharetta, GA (US)

(21) Appl. No.: 13/869,646

(22) Filed: Apr. 24, 2013

Related U.S. Application Data
(60) Provisional application No. 61/757,477, filed on Jan. 28, 2013.

(51) Int. Cl. G06F 17/21

(52) U.S. Cl. CPC G06F 17/212
USPC 715/243

(57) ABSTRACT

A specification document, such as a specification of a product, is automatically generated. A modular database structure is used to populate a template. Product modifications are incorporated, resulting in change, alteration, or different data being in the specification than without the modification. For example, a modification may result in the use of a different enclosure for the as-built product. The specification document includes dimension values, images, and/or other information representing the modification and the as-built product rather than a base product without the modification.

### RELATED APPLICATIONS

The present patent document claims the benefit of the filing date under 35 U.S.C. §119(e) of Provisional U.S. Patent Application Ser. No. 61/757,477, filed Jan. 28, 2013, which is hereby incorporated by reference.

### TECHNICAL FIELD

This disclosure relates in general to the field of product specifications, and, more particularly, to automatic generation of product specifications.

### BACKGROUND

Document generating systems populate form templates with content. A user may prompt a system to display information on a product of interest in a pre-defined form by entering minimally required information on that product via a graphical user interface (GUI). For example, the user enters a product or catalog number. The system then retrieves the form content from a data storage device on a computer. The form includes the requested content and is made available to the user to view, print and possibly save as a separate document. However, separate forms are provided for separate products. Alternations or modifications are either treated as separate products or not reflected in the product specification. The dimensions or other representation of the actual product as built may not be reflected in the specification.

### SUMMARY

By way of introduction, the preferred embodiments described below include methods, systems, instructions, and computer readable media for generating a specification document, such as a specification of a product. A modular database structure is used to populate a template. Product modifications are incorporated, resulting in change, alteration, or different data being in the specification than without the modification. For example, a modification may result in the use of a different enclosure for the as-built product. The specification document includes dimension values, images, and/or other information representing the modification and the as-built product rather than a base product without the modification.

In a first aspect, a method is provided for generating a specification document of a product. Input of a product number and a modification for the product is received. A processor populates a template with first data based on the product number. The processor populates the template with second data based on the modification. The second data represents a difference from base data corresponding to the product number. The specification document of the product is output. The specification document is a function of the template populated with the first and second data.

In a second aspect, a non-transitory computer readable storage medium has stored therein data representing instructions executable by a programmed processor for generating a specification document of a product. The storage medium includes instructions for identifying the product from a product number, identifying a modification from a modification code, selecting an enclosure as a function of both the product and the modification, and generating the specification document with a dimension value represented in the specification document, the dimension value being a function of the enclosure, and with an image of the product including the modification.

In a third aspect, a method is provided for generating a specification document. Input of a product number and a modification is received. A processor alters an image of a product associated with the product number. The alteration is based on the modification. The specification document is output with the altered image.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a simplified block diagram of a computer system for generating a product specification according to an embodiment;

FIG. 2 illustrates a database schema for storing information according to an embodiment;

FIG. 3 is a flowchart diagram of one embodiment of a method for generating a product specification;

FIG. 4 is a flowchart diagram of another embodiment of a method for generating a product specification;

FIG. 5 illustrates an exemplary Graphical User Interface (GUI) for user input;

FIG. 6 illustrates the exemplary GUI of FIG. 5 with input product and modification information;

FIG. 7 is a flowchart diagram of one embodiment of a method for populating product information from a product code;

FIG. 8 is a flowchart diagram of a method of generating enclosure specifications for a specific product, according to one embodiment;

FIG. 9 is a flowchart diagram of a method of generating factory modification specifications for a specific product, according to one embodiment;

FIG. 10 is a flowchart diagram of one embodiment of a method of generating product images;

FIG. 11 illustrates an exemplary product image without factory modification overlays;

FIG. 12 illustrates the exemplary product image of FIG. 11 with factory modification overlays; and

FIGS. 13-16 show an example product specification.

### DESCRIPTION OF EXEMPLARY EMBODIMENTS

Product specification documents are automatically generated and/or printed via a document generation system in response to data received from a user via a GUI. The user puts in a catalog or product number and the user selects one or more modifications (e.g., added parts, change in quantity of a component, and/or rearrangement of parts) of the product.

Data associated with the modifications is acquired from a table, and the specification for the catalog or product number is changed based on the modification data. The content output is dynamically altered based on product alterations or modifications of the standard product desired by the user. For example, the dimensions of the product are altered to account for the modification where the modification data indicates an addition or subtraction to the base or product dimension number. The as-built or to-be-built construction of the modified product is automatically determined. The automatically generated product specification for the construction includes dimensions, a dimensional drawing, and/or images specific to the modified product. For the image, an icon or other representation of the modification (e.g., add on) is overlaid or added to the product drawing.

The goal is to generate a product specification that includes modifications without having to create and store specifications for each possible combination of products and modifications. A user may dynamically generate the specification document based on indication of the product and any modifications. The product code and modification code may be the only indications needed, avoiding manual alteration of values used in the specification or avoiding generalization. Other inputs may be used.

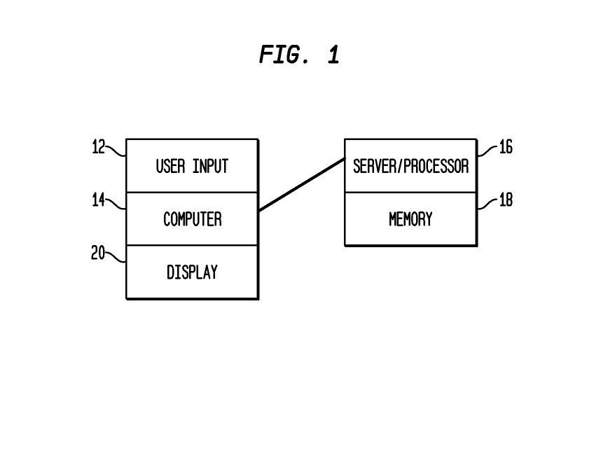

FIG. 1 illustrates an exemplary system for automatically generating specification documents. The system as shown represents a client-server relationship. The computer 14, user input 12, and display 20 are client devices, and the server or processor 16 and memory 18 are server devices. The client devices connect with the server devices over a network, such as a local area, wide area, intranet, private, and/or Internet. In other embodiments, a given computer alone automatically generates the specification document without operating in a client-server arrangement. Additional, different, or fewer components may be provided.

The user input 12 is a keyboard, mouse, trackball, touch pad, capacitive sensor, pedal, knob, button, slider, touch screen, infra red receiver, radio frequency receiver, network interface, combinations thereof, or other now known or later developed input device.

The computer 14 is a laptop, personal computer, workstation, tablet, phone, personal data assistant, or other data processing device. The computer 14 connects with the user input 12. The user input 12 is integrated with or separate from the computer 14.

The display 20 is a CRT, LCD, flat panel, plasma, projector, printer, combinations thereof or any other now known or later developed display. Using a graphics processing unit or other hardware or software, the display 20 generates black and white or color pixels in a Cartesian or other coordinate format for presenting a graphical user interface and outputting a specification. The display 14 is operable to display the generated specification.

The server or processor 16 is a general processor, applications specific integrated circuit, digital signal processor, field programmable gate array, multiple processors, analog circuit, digital circuit, network server, graphics processing unit, combinations thereof, or other now known or later developed device for serving or running an application. In one embodiment, the server or processor 16 is a processor for remotely generating a product specification based on input from the user input 12. In another embodiment, the processor 16 is a processor of the stand-alone computer 14 for locally generating the product specification based on input from the user input 12.

The memory 18 stores data, such as a database structure used to generate the specification. Other data may be stored, such as a template or a created product specification.

Alternatively or additionally, the memory 18 is a non-transitory computer readable storage medium storing data representing instructions executable by the programmed processor for generating a specification document of a product. The instructions for implementing the processes, methods and/or techniques discussed herein are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone, or in combination. Likewise, processing strategies may include multiprocessing, multitasking, parallel processing, and the like.

In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU, or system.

The user is a customer or someone affiliated with the company providing the product. For example, the system is a sales, marketing, or technical resource tool for use by a company for the products of the company. As another example, the user is a customer looking to download a copy of the specification, such as in a client-server arrangement. The user requests a specification. The request may be by input of the product or catalog number and any modifications. The processor 16 uses the received input information to create a specification document and output the specification document to the user.

The processor 16 creates the specification document from data stored in the memory 18. The data is part of a data table or a modular collection of data tables. For example, the data structure and specification assembly are handled as Microsoft Excel applications. In the Excel embodiment, a plurality of worksheets functions as data tables. The data tables include cells populated with data, links, and/or formulas. Other database systems may be used. A manually created database application may be used.

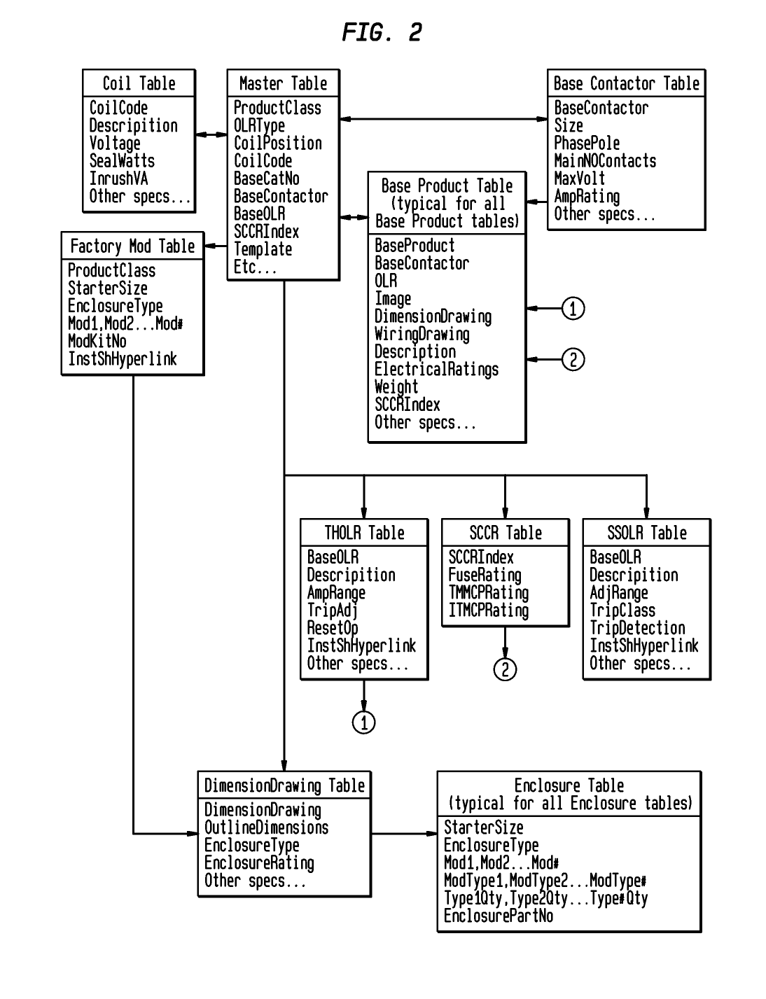

FIG. 2 shows an example modular database structure for industrial or other control products. The products include one or more coils, contactors, thermal overload relays, short circuit current ratings, solid state overload relays, and enclosures. FIG. 2 shows tables for these various components, as well as a base product table (e.g., motor starter, transformer, panel, or controller), a modification table, a master table, and a drawing table. Other arrangements of tables may be used, such as combining tables, using different tables, and/or using additional tables. In other embodiments, different tables correspond to products in a different field (e.g., heating, ventilation, and air conditioning (HVAC), toys, or agricultural). Tables for products from different fields may be used as part of a same or in a different database structure.

The database is a relational database of a plurality of interrelated data tables. Lines show interconnection of the tables. The circles with 1 and 2 represent line connections. The tables are used to determine product specifications associated with the catalog number and modifications. Each data table includes a plurality of records each having one or more data fields. Formulas or links are used with the user input to retrieve the correct data from the data tables. Some of the resulting data is used directly to populate fields. Other resulting data is used in formulas to retrieve data from other data tables. Any relational data structure may be used.

For generating the product specification, one or more templates are provided. The templates are structured forms to be populated from the data tables of the worksheets. The templates may be represented as Excel documents or other forms with fields or cells to be filled by accessing the data tables. The template defines the output.

In one embodiment, a plurality of templates is provided. The system determines the most appropriate template to use based on the user input of the product or catalog number.

For populating the selected template, an application searches the data tables and populates the fields of the template. In one example, visual basic code is used for assembling the data into the template. Other types of code may be used.

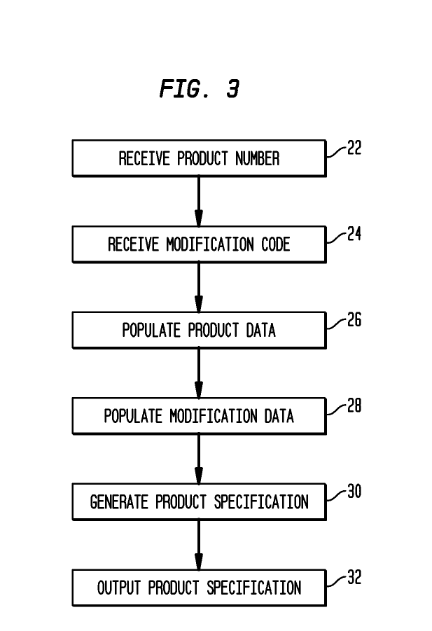

FIG. 3 shows a method for generating a specification document. The method is implemented using the system of FIG. 1, a processor, a server, a computer, a database of FIG. 2, other database, and/or a different system. In general, a processor receives input including modifications and uses the input to populate a product specification that includes values, data, and/or images set, at least in part, based on the modification. The product specification is directed to the as-built or to-be-built product with specific optional features.

Additional, different or fewer acts may be provided than shown in FIG. 3. For example, acts for accessing other types of data, acts for transmitting an output product specification, and/or acts for storing the product specification are provided.

The acts are performed in the order shown or different orders. For example, the modification input is received in act 24 prior to, simultaneously with, or after receiving input of the product code in act 22. As another example, the data associated with one or more modifications is populated into the template before data associated with the product class.

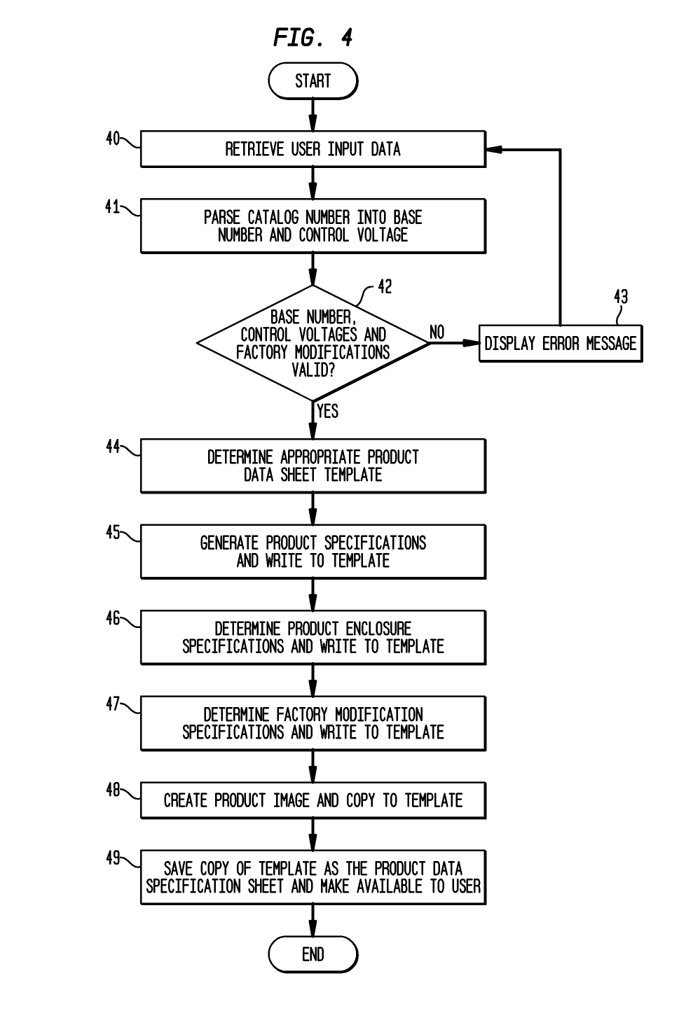

FIG. 4 shows another embodiment of a method for generating a specification document of a product. The acts of FIG. 4 are implemented by a same or different system than the acts of FIG. 3. The same system may implement a combination of some or all of the acts of FIGS. 3 and 4 in a given application to generate a product specification. Alternatively, FIGS. 3 and 4 represent alternative example embodiments.

In act 40 of FIG. 4, user input data is retrieved. This represents a pull operation by the processor. In acts 22 and 24 of FIG. 3, user input data is received. The receipt may be in response to a pull operation or in response to a push operation. For example, a server receives input pushed from a client application handling input. Push, pull, or both types of operation may be used.

In act 22, the user input is of a product number. The product number may include text, symbols, numerals, other code, or combinations thereof. For example, the product number is “14DUD32BF.” This product number is the same or different than a catalog number. Any reference to a product may be used as the product number. The product number may or may not include any numbers.

In act 24, the user input is of a modification. The modification is a code, such as text, symbols, numerals, other code, or combinations thereof indicating the modification. For example, the modification code is “A3,” “FA,” “FC,” or “BA.” The factory modifications are optional accessories to the standard product and may or may not require alterations to the standard or base product. Exemplary factory modifications include, but are not limited to, start/stop push buttons, on/off indicator pilot lights, and control power transformers. The modifications correspond to change to the base product, such as the modification resulting in a size for the as-built product different than the size of the base product. More than one modification may be input, such as inputting two, three, or more modifications.

The system automatically generates and populates a template form with content, drawings, and images based on information entered by a user and received in acts 22 and 24. A user enters minimally required information (e.g. catalog number of standard product and desired factory modifications). Only the product number and modification codes are entered. The user does not enter any values other than the product number and modification code that are displayed on the product specification. In other embodiments, other information is entered.

In one embodiment, the modification code is included as part of the product number, such as a list of one or more modifications included on an end of the product number. In other embodiments, the modifications are separate than the product number.

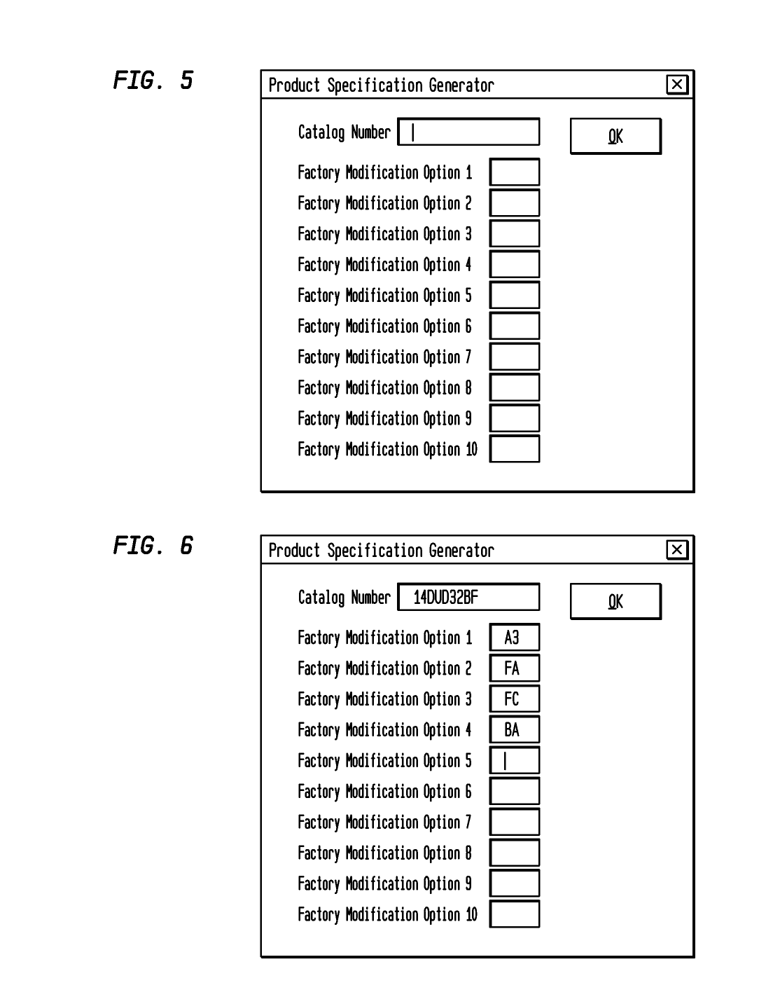

The input is entered via a graphics user interface (GUI). FIG. 5 shows an example GUI for entry of the product number and modification codes. A single field labeled for entry of the product number is provided. Other fields are provided for entry of modifications. FIG. 6 shows an example of entry of a product number and four modifications. A single field for entry of a single modification or for multiple modifications may be used. Other GUI arrangements may be provided.

The product number and modification codes allow for identification of the base product and the modifications for a given as-built or to-be-built product. For example, the product code identifies a product class, such as a motor starter. The product class may be of any grouping, such as a starter, a motor starter, or a 200V motor starter. Any level of generalization may be used. Within the generalization, various additional components may be provided. For example, different coils, contactors and/or relays are used for different products in the same class.

The base product corresponds to the specific product (i.e., type or class of product (e.g., motor starter) and product components (e.g., coil, contactor, and relays)) but without the optional modifications. The base product may be for components needed for operation while the modifications are for optional components not needed for operation.

The base product has particular characteristics defined, at least in part, by the product requirements. For example, the size of coil, voltage rating, and enclosure dimensions are provided for the base product. The modifications may result in differences in one or more of these characteristics. The base product and the modifications are identified to determine the specifications.

To determine the characteristics of the base product, the product number is parsed. FIG. 4 represents the parsing in act 41. In FIG. 3, the parsing is treated as part of act 26. The product number is a code that includes information about different components. One sub-part (e.g., the first two digits) references a specific or given product class, such as “14” indicating motor starters. Different designators in a given place determine the specific component for a given type. For example, “14” may be a product class, while “D” in the third position refers to a specific coil, “U” refers to a specific contactor, “D” in the fifth position refers to a specific thermal overload relay, “32” refers to a short circuit current rating, and “BF” refers to a specific solid state overload relay. The parsing identifies the components and the product class.

FIG. 4 includes a validation check in act 42. The product code and/or modifications are checked. If a non-existent product code or modification code is received, an error results. If an impossible combination of base product and modification is received, an error results. If any part of the product number or modification is improper, an error message is generated in act 43. The error message may be specific to the error, such as a different message for improper modification code than for improper product code.

In act 44, a template is selected. The specification is assembled from the stored data associated with the base product and the selected modifications. Once the information is validated, the system determines the appropriate template to populate. Any selection may be used. Different templates are provided for different classes. In one example, a template for product class “14” (e.g., motor starter) is provided and selected. The same template may be selected for multiple but not all product classes. Other levels of generalization may be used, such as using different templates for different components or combinations of components.

In act 45 of FIG. 4 and act 26 of FIG. 3, the product specification is generated by writing data to the template. The data corresponds to the base product (e.g., product class and components). The database is used to populate the template for the product specification. For example, the relational database of FIG. 2 is used to determine values or other information for input into the fields of the template.

The data is accessed based on the product number. By parsing the product number, the corresponding data is identified. For example, the product number is separated into codes or separate codes of the product number are identified. The codes for a product class, a coil, a contactor, a relay, and a rating are found and used to access the corresponding data of the appropriate data table. Using different portions of the parsed product number, data from the different tables is located. Using a look-up, search, or other function, the characteristics of the product class, coil, contactor, relays, and rating are found with the separated codes in a product class data table, a coil data table, a contactor data table, a relay data tables, and a rating data table, respectively. Other characteristics, product classes, and/or data tables may be used.

The accessed data is assigned to the fields of the template. The data from the data tables is linked to the fields and/or copied to the fields. The template is populated by indicating where data for the field is located or by filling in the field with a copy of the data. Different fields of the template refer to different types of data or characteristics. Using the formulae of the fields, the data table field from which to acquire the data is identified. A series of linking or sequential formulae and/or references may be used to navigate through the relational database to determine the data for a given field. Vertical look-up operations are performed to populate the template.

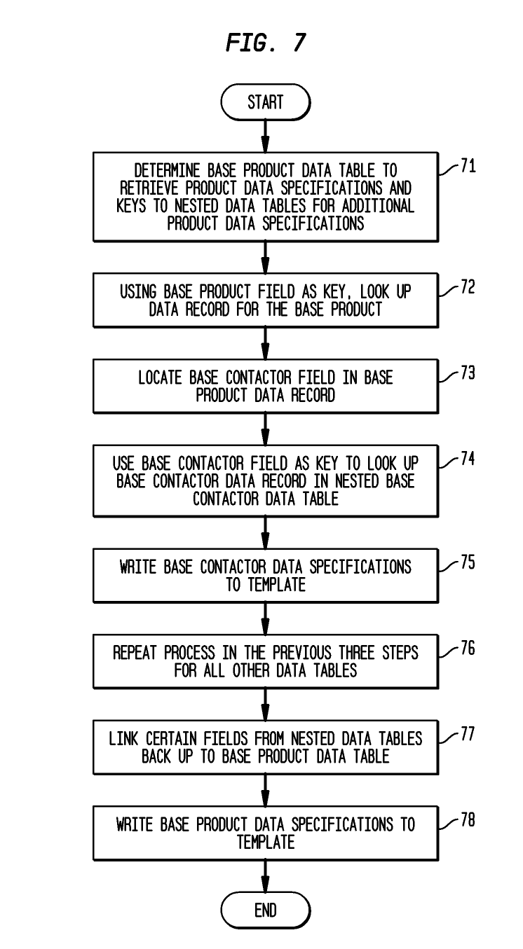

FIG. 7 shows one example embodiment for populating the template based on the base product information. A master table is used to generate the specification, such as controlling the parsing and calling of a template and corresponding population functions. Additional, different, or fewer acts than shown in FIG. 7 may be used.

In act 71, the master table is used to determine the base product data table, such as by finding a base product data table based on the product class. The specification and keys to nested data tables for components are accessed in the base product data table. A vertical look-up is configured by using the parsed information. In act 72, the class of the base product is used as a key to look-up the data for the base product. Some data is specific to the product class. In act 73, the contactor from the product number is extracted or parsed. For example, “D” is extracted from the product number where the third digit represents the contactor. In act 74, the contactor code (e.g., “D”) is used as a key to look-up the data for the contactor data in the nested base contactor data table. In act 75, the base contactor data specifications from the base contactor data table are written to the template. For example, the contactor data associated with contactor “D” is extracted and used. The contactor data associated with other contactors are not used unless shared. In act 76, acts 73, 74, and 75 are repeated for other components (e.g., coil, thermal relays, overload relays, ratings, disconnects, breakers) identified in the product code and/or referred to through the master or base product table.

In act 77, one or more fields may be linked from the component data tables to the base product table. For example, a nested loop or sequence of look-up operations is performed. A data table for one component may need information from another component table to determine the data for a field in the template. By linking through the base product table, the sequence of look-ups for obtaining the data may be performed.

In act 78, the data from the base product data table, links, or other tables are written to the template. The template is populated. The data for the specification from the product class and components is populated without reference to the modifications. Additional, different, or less data may be populated based on the base product. For example, the wiring diagram includes options associated with different modifications, so the same wiring diagram is used despite any modifications. A self-contained depository of wiring diagrams may be included. The system selects the appropriate wiring diagram based on the user input of the product or catalog number and inserts the wiring diagram into the template to generate the product specification document. The wiring diagram may instead be provided as part of the template. Where the product does not include wiring, a wiring diagram is not included. Other types of information may be included depending on the product, such as a safety data sheet.

In other embodiments, some or all of the data for a component or the base product depends on the modifications. For example, the wiring diagram may be different for different modifications. Separate, pre-created wiring diagrams are selected based on the modifications and base product. Alternatively, the wiring diagrams are treated like the images below where different overlays are added to a base diagram. The overlays are determined from the modifications.

In act 28, data reliant on the modification or modifications are populated to the template. In FIG. 4, act 28 is divided into separate acts 46, 47, and 48. The enclosure, links and/or values, and image used in the product specification depend, at least in part, on any modifications. Additional, different, or fewer acts and/or corresponding data may depend on the modification codes.

The template is populated with data based on one or more modifications. The modification code is used to determine characteristics of the as-built or to-be-built product. Multiple modification codes or multiple of the same code may also be used to determine characteristics. Different modifications may be associated with different characteristics and corresponding data. The cumulative modifications may result in different characteristics and corresponding data.

The data represents a difference from the base data for the product number. For example, the base data may provide a value or an image. Without the modification, this base data from the population of act 26 is used in the specification. With the modification, different data is used instead of or written over the data based on the product number.

Other data for the modification may represent additional information, such as information only corresponding to the modification. For example, a link to modification information may be unique to the modification rather than a difference while a value of a dimension measure may be different due to the modification (e.g., 10 mm instead of 8 mm).

In act 46, an enclosure is determined based on the modification. The determination may be based on other information as well, such as the modification and the base product. The enclosure is selected as a function of both the product and the modification. Different modifications may result in using the same or different enclosures than assigned to the base product. For example, one modification or a sufficient number of modifications may not fit on the enclosure used for base product, so a different enclosure is used for such as-built or to-be-built products. The modification information is used with the database or data tables to determine an enclosure.

The enclosure is selected from a list of enclosures. A given class of product or product with specific components may have a default enclosure. Other enclosures may be possible for the product due to modifications. A data table indicates the available enclosures and/or links the enclosures to modification requirements. For example, a data table of modifications provides information used to determine dimension values and enclosures. The dimension values may be used with the modifications to determine the enclosures and/or vice versa.

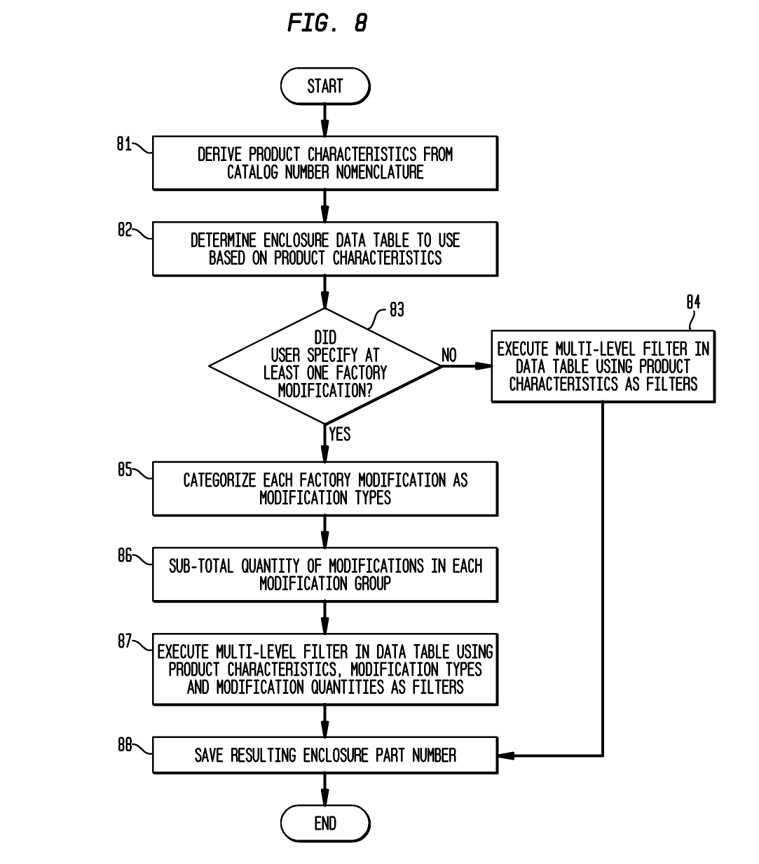

FIG. 8 represents one example flow for selecting an enclosure based on the product class and modifications. The product characteristics are derived form the product number in act 81. The characteristics may be for the class and/or components. By parsing the catalog number and obtaining additional information from the data tables, the system determines characteristics of the product used to derive the specifications of the enclosure used in the construction of the product. In act 82, the enclosure data table to use is determined based on the product characteristics. For example, different enclosure data tables are used for different product classes.

In act 83, a determination of whether a modification exists is made. If no factory modification exists or is entered by the user, then an enclosure is selected in act 84. Any selection may be used, such as a look-up based on components and/or product class. In one embodiment, the system executes a multi-level filter in the enclosure data table using the product characteristics as filters. Different components and the product class are used to determine a matching enclosure. The filtering is multi-level as more than one input is used for the selection, such as the class and components. Different filters may be used to form the multi-level filter. The filtering may be sequential, such as navigating through a tree structure to find the enclosure. Alternatively, the filtering uses a combination of inputs to determine a given enclosure that matches the product without modifications.

If the user enters one or more modifications, each of the modifications is categorized in act 85. The type of modification is determined from the modification code. In act 86, the number of modifications is determined. The quantity of modifications within each category or group is sub-totaled. Different types of modifications may have limited space or position availability on a given enclosure. Other enclosures may allow for different numbers of different types of modifications.

In act 87, a multi-level filter is applied. The number of modifications, types of modifications, and characteristics of the base product are used to select an enclosure. The number of modifications is by type, but may alternatively or additionally be a total across all types. The characteristics of the base product may be included through selection of the enclosure data table for the base product. The filtering is then performed using that selected data table. Alternatively, one or more characteristics (e.g., components, class, or data associated with components or class) are used in addition to modification information as inputs to the multi-level filtering. The filtering identifies an enclosure capable of use with the number and types of the modifications and characteristics of the base product.

In act 88, the resulting output of the filter is the enclosure part number. From the enclosure part number, data for the specification, such as the outline dimensions as well as the outline drawing of the enclosure, may be realized. This information is written to the template. Due to the modifications, a different enclosure than used in the base product without modifications may result. For example, a given modification may require a hinged door, a larger enclosure, an enclosure with a different cut-out, a sealed enclosure, or other enclosure characteristic. The number of a given type of modification may require an enclosure with sufficient cut or knock-outs for the modifications. The resulting enclosure is identified and the characteristics of the enclosure used in the specification are obtained from the enclosure table and populated into the template. For example, the size or values for dimension measures for the selected enclosure are populated. This size is based on both the product number and the modifications. The size may account just for the selected enclosure or may include added or removed measure due to the modification (e.g., switch adding 0.5 cm). The enclosure is determined for populating corresponding characteristics of the enclosure into the template.

In act 47 of FIG. 4, further data for populating the template may be determined based on the modification or modifications. Modification specific data is determined. For example, a link to specific information about the modification is identified. As another example, data representing characteristics of the modification is identified. The template is populated with the link or other type of data (e.g., values or ratings).

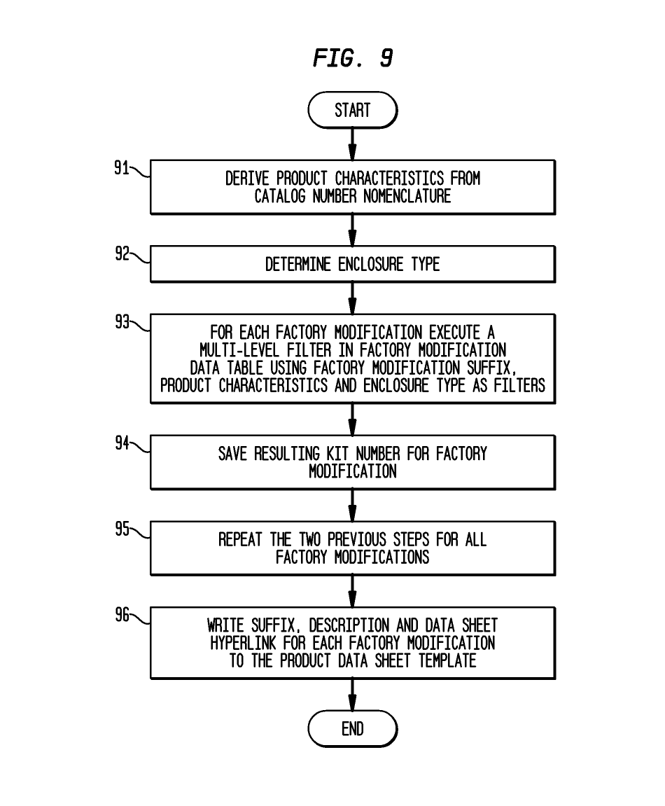

FIG. 9 shows an example embodiment for adding a link for the modification. Other, different, or additional acts may be provided. The method may be used to populate other types of modification data. In other embodiments, a different method is used for populating modification data into the template.

In act 91, product characteristics are determined from the product number. Any characteristic may be used, such as a voltage or current level that may be associated with modifications. Act 91 may be optional. In act 92, the enclosure type and/or other enclosure characteristic is determined. For example, a class of the enclosure selected is used, such as a sealed enclosure, a hinged door enclosure, a boxed enclosure, or other type.

In act 93, a multi-level or other filter is executed. Using the modification code (i.e., suffix), product characteristics, and enclosure type as the filters, a sequence, nesting, parallel, or combined filtering is used to identify the specific modification. For example, a hand-off-auto selector switch may have a modification code of “A3.” There may be different sizes, rating, or other characteristics for a specific selector switch. Using the enclosure, a physical size may be determined. Using the product characteristics, a rating or electrical characteristic may be determined. The factory modification data table is used by the multi-level filter to select a specific switch. The result of the filtering is selection of a specific hand-off-auto selector switch appropriate for the product and enclosure. A modification kit number or other designator of the specific modification part is identified. From the modification kit number, the specifications of the modification may be realized. The data from the kit and/or the modification suffix, description and data sheet hyperlink for the modification are then written to the template. The hyperlink connects to the specification one or more sources of further information about the modification to the specification document. In act 94, the selected information is stored. The storage may be of the actual information or be a pointer for the selection.

In act 95, the filtering of act 93 and storing of act 94 are repeated for other modifications associated with the as-built or to-be-built product. In act 96, modification information is added to the template. A link from the information is provided in the template or the data itself is added in the template. Any modification information may be added, depending on the template. For example, the modification code or suffix (e.g., “A3”), a descriptor (e.g., “Hand-Off-Auto selector switch”) and a hyperlink are added to three corresponding fields of the template.

In act 48 of FIG. 4, further data in the form of one or more images of the product is populated into the template. Any type of image may be created. For example, a wire image showing dimensions is created. As another example, a perspective view of the product is created. The image may be of an outside, inside, or both. The image may be with a door open or closed. Multiple images may be provided, such as a front view and a side view.

An image is stored for the base product. Alternatively or additionally, an image is stored for the selected enclosure. The image is a base image free of optional modifications. The base image is altered based on one or more modifications. Where the modification would be viewable given the perspective of the image, the image is altered to represent the modification. The image of the product associated with the product number is altered to reflect the modification.

The modification is reflected by adding to, moving, or removing a part of the base image. For example, the base image includes one or more recesses in the housing. Where the modification is to be placed in the recess, the recess is covered with an image of the modification. An icon or other image is overlaid on the base image. If the image of the modification does not cover the entire recess, a part of the recess may be removed to represent the knock-out of the recess for the modification.

A self-contained depository of images is included in one or more data tables or by relational link. The system selects the base image or images based on the user input of the product or catalog number or selected enclosure, and the system selects modification images based the selection of modifications. The corresponding images are superimposed to create an as-built image. The representation of the modification is overlaid on the base image.

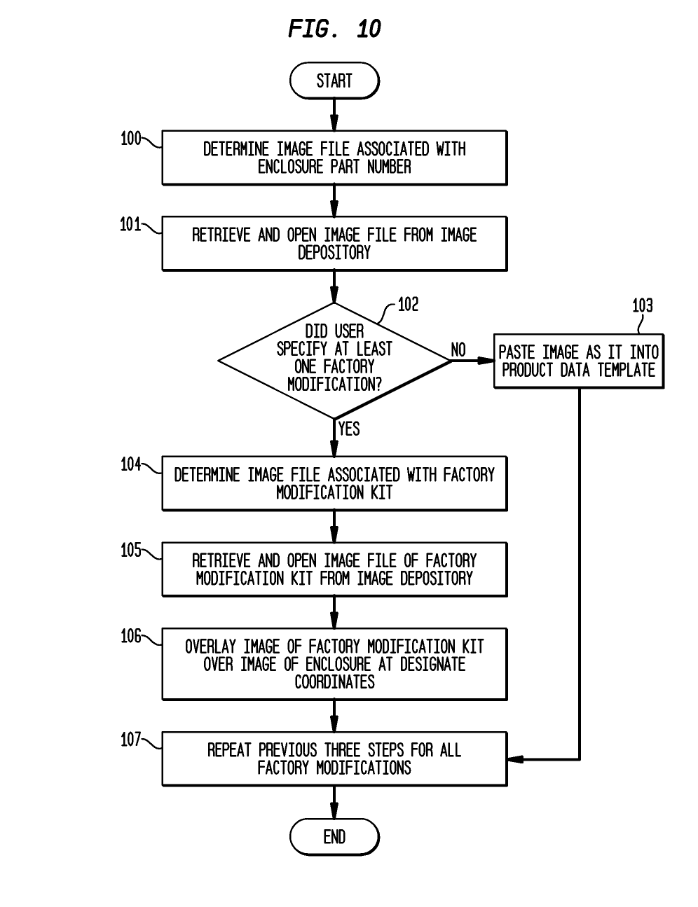

FIG. 10 shows one example embodiment of creating the image of the as-built or to-be-built product. Additional, different, or fewer acts may be provided. A different method may be used.

In act 100, an image file for the selected enclosure is identified. The selected enclosure is associated with a part number. The part number is used to select the image file for the enclosure. In act 101, the image file is retrieved from an image depository. In act 102, a determination of whether a modification is included is made. If there are no modifications, the image added or pasted to the template in act 103.

If there is a modification, the image file associated with the factory modification is determined in act 104 and retrieved in act 105. The modification image file represents an image of the modification and not the enclosure. Rather than having separate images of the entire enclosure with different combinations of modifications, the base image is to be altered by the modification images. In act 106, the image of the modification kit is overlaid onto the image of the enclosure at designated coordinates. Depending on the modification, the number of modifications, and enclosure, a priority, ranking, or rule set dictates the placement of the modification or modifications on the enclosure. The modification images are positioned relative to the base image. In act 107, acts 104, 105, and 106 are repeated for additional modifications.

The resulting or modified image is populated or pasted into the template by link, by adding image data, by reference, or by adding the file to the template. The altered image is inserted into the template to generate the product specification document.

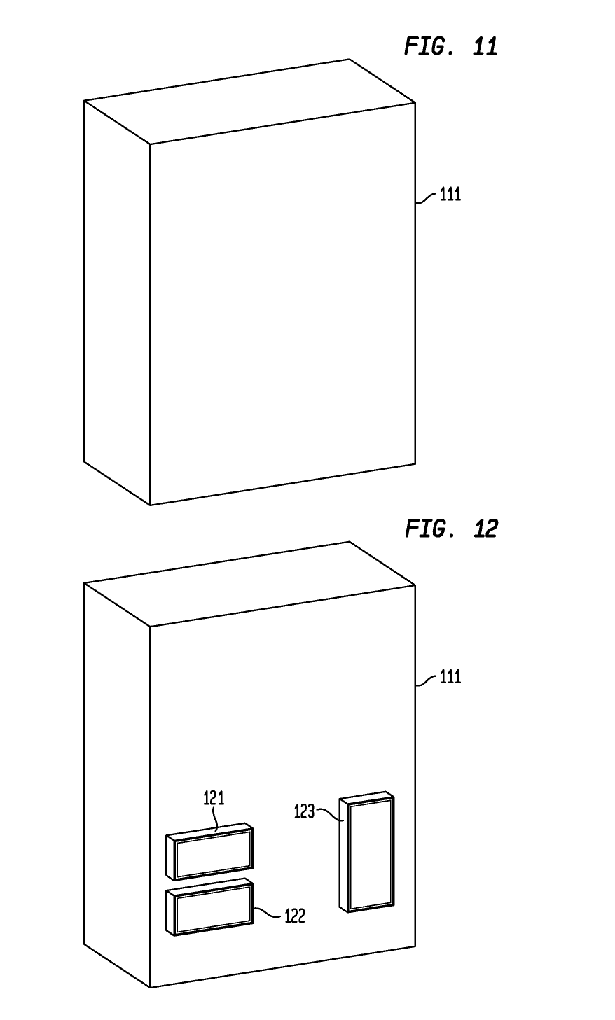

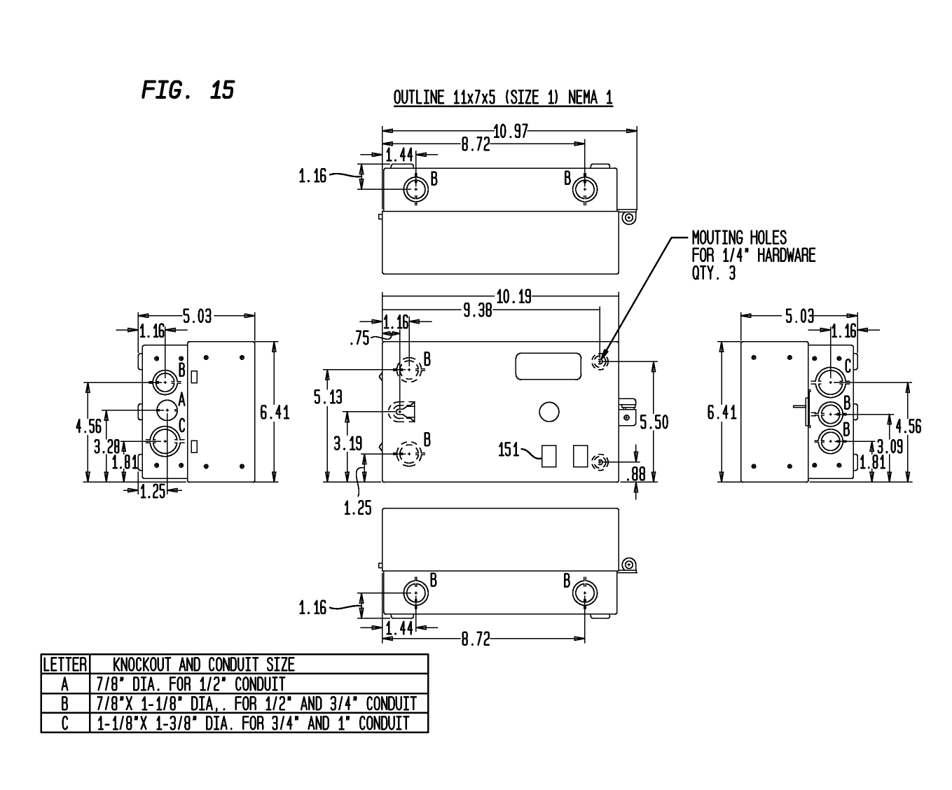

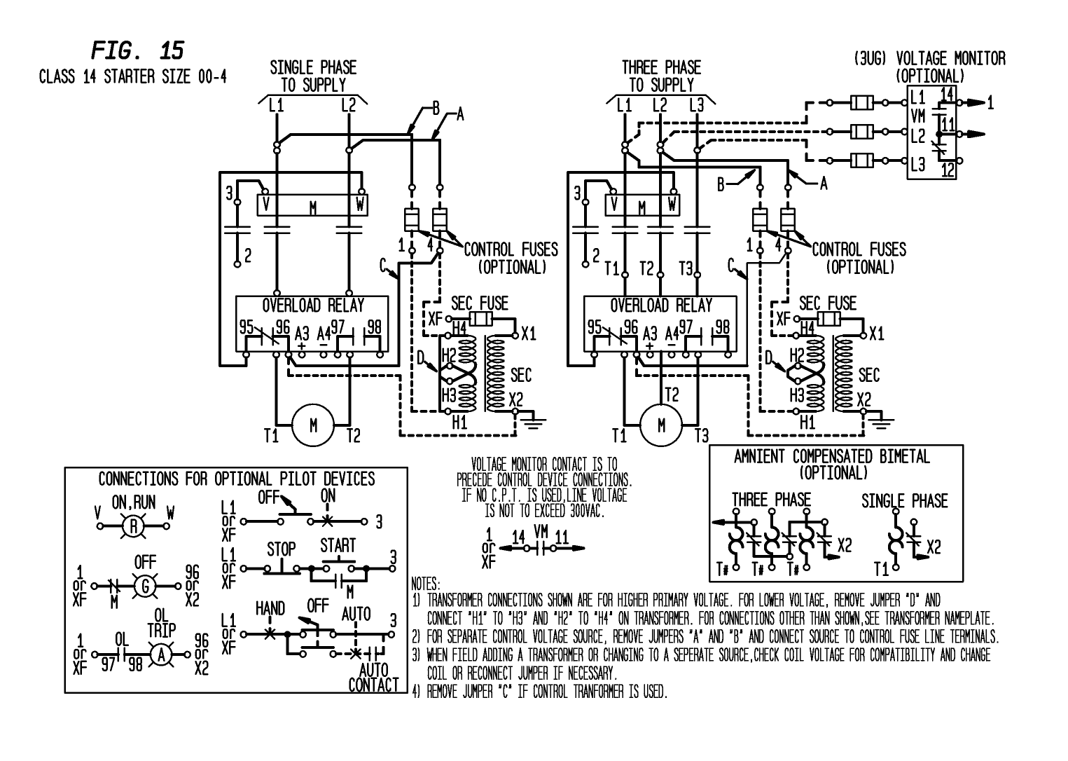

FIG. 11 shows a base image of a simple enclosure 111. The image is of a housing or visual component of a product. FIG. 12 shows the base image modified to include three modifications. One start/stop push button 123 and corresponding red and green indicator lights 121, 122 are added as modifications or a modification. Three corresponding icons or an image of the lights and button together are overlaid on the base image of FIG. 11. FIGS. 11 and 12 are for a visual image of the enclosure. In alternative or additional embodiments, the image is a wire diagram, such as represented in FIG. 15. Modifications are added to the wire diagram, resulting in extended or shrunk lines (distances) and/or added, moved, or removed parts.

Referring again to FIG. 3, the product specification is generated in act 30. The specification document is generated from the template. The template encodes a layout for the specification. Alternatively, the information linked to or stored in the template is used by an application to format the specification. The specification may have any format.

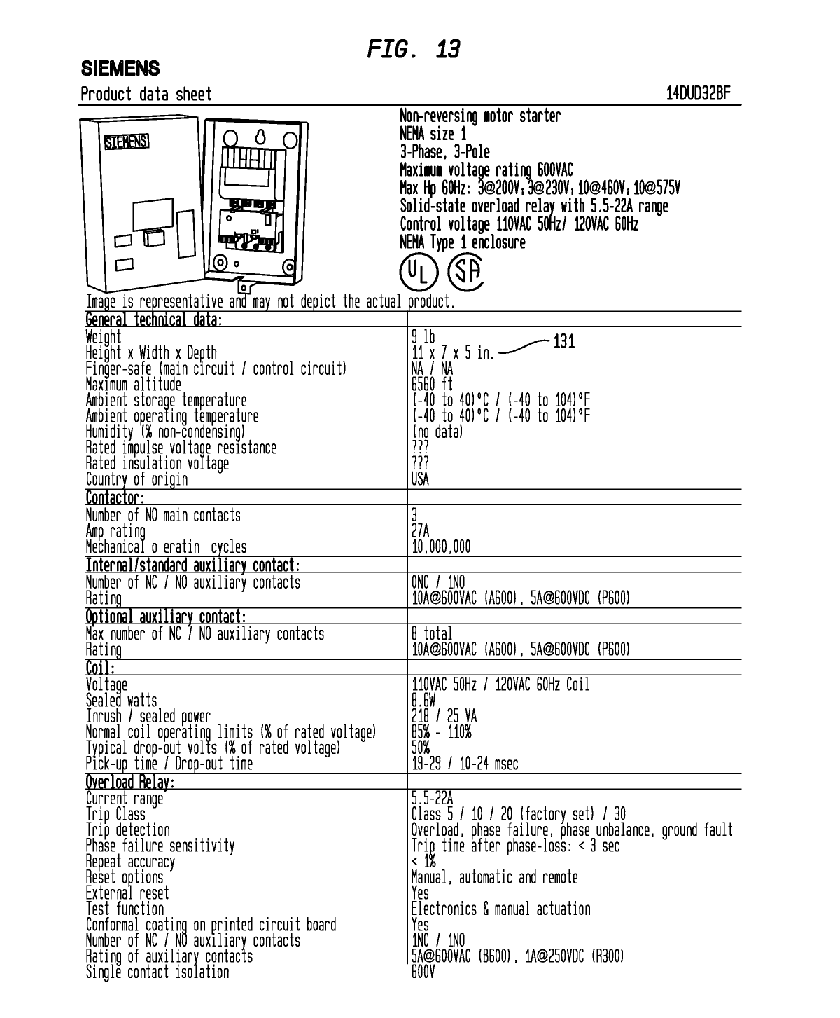

FIGS. 13-16 show an example product specification. Additional, different, or fewer types of information may be included.

In FIG. 13, two images with any overlaid modifications are provided. One or both of the images may include alterations to show the modification. The weight and/or dimension (e.g., height, width, and depth) data may be different due to the modifications. The other data may be based on the base product regardless of modification. Additional, different or fewer fields may be affected by the modifications.

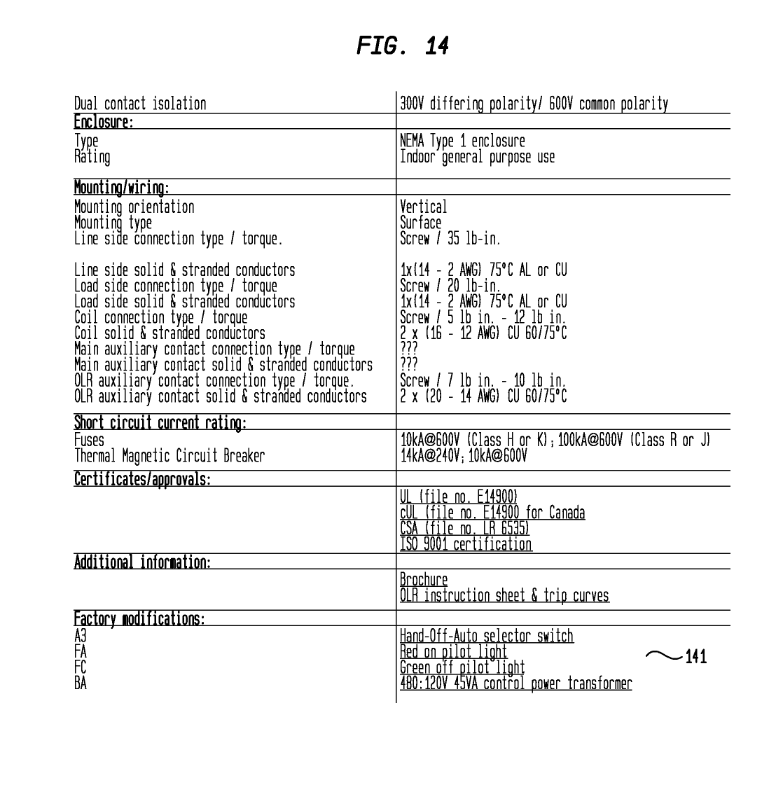

In FIG. 14, the modification codes (i.e., Factory Modifications), the corresponding descriptions (e.g., “Hand-Off-Auto selector switch”), and link (e.g., represented by underlining) are added due to the modification codes. The remaining information is based on the base product regardless of the modifications. Alternatively, the enclosure and/or mounting information may vary due to a change in the enclosure dictated by one or more modifications. Similarly, the certificates/approvals may be different due to different enclosure and/or modifications.

In FIG. 15, another image or images associated with the enclosure are provided. Since the enclosure may be dictated, at least in part, by one or more modifications, the enclosure wire image may be different due to the modifications. Since the modifications may change the overall dimensions and/or change an outline shape, the enclosure wire image may be different due to the modifications.

In FIG. 16, a wiring diagram is provided. Where the wire diagram is generic to various modification options, the same wiring diagram may be used regardless of the modifications. For example, the lower left box represents possible modifications. In other embodiments, the wiring diagram is adapted to modifications. A base wiring diagram may not show the optional modifications. Where a modification is added, the corresponding change in the circuit is provided as an overlay or other alteration to the wiring diagram.

In act 49 of FIG. 4, the template is saved as the product specification sheet. Where the template incorporates or dictates the format, saving the template is saving the product specification. In other embodiments, the generated product specification is saved. The modification adapted specification is saved to make the product specification available to the user. The user may then print, save and/or email the document. The document is printed on paper, displayed on a display device, or transmitted through a computer network.

In act 32 of FIG. 3, the generated specification document is output. For example, a document represented by FIGS. 13-16 is output. The document may be a single file or may be formed from multiple files. The information represented by the hyperlinks for the modifications is embedded in the specification document or requires Internet access.

The specification document is specific to the product with any modifications. Rather than receiving a specification generalized to the base product and/or representing various options that may or may not have been included, the specification is directed to the base product with the specific modifications for a given version of a product. The dimensions, images, modification list, and/or other information are directed to the specific as-built or to-be-built product. For example, the images reflect the modifications. As another example, a height value reflects both the enclosure driven by a modification as well as accounting for the added height due to the modification component itself.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

What is claimed is:

1. A method for generating a specification document of a product, the method comprising:
receiving input of a product number for the product;
receiving input of a modification of the product;
populating, by a processor, a template with first data based on the product number;
populating, by the processor, the template with second data based on the modification, the second data representing a difference from base data corresponding to the product number; and
outputting the specification document of the product, the specification document being a function of the template populated with the first and second data.

2. The method of claim 1 wherein receiving the input of the product number and the modification comprises receiving at a server from a client.

3. The method of claim 1 wherein populating with the first data comprises:
parsing the product number;
locating the first data in a plurality of data tables based on different portions of the parsed product number; and
assigning the first data to fields of the template.

4. The method of claim 3 wherein parsing comprises separating codes for a product class, a coil, a contactor, a relay, and a rating in the product code, and wherein locating comprises looking-up characteristics of the product class, coil, contactor, relay, and rating with the separated codes in a product class data table, a coil data table, a contactor data table, a relay data table, and a rating data table.

5. The method of claim 1 wherein populating with the second data comprises adding a link for the modification.

6. The method of claim 1 wherein populating with the second data comprises determining an enclosure based on the modification and populating characteristics of the enclosure as the second data.

7. The method of claim 1 wherein populating with the second data comprises altering an image based on the modification.

8. The method of claim 1 wherein populating with the second data comprises identifying the second data as a function of both the modification and the product number.

9. The method of claim 1 wherein receiving the modification comprises receiving first and second modifications, and wherein populating with the second data comprises filtering by a number of the first and second modifications, types of the first and second modifications, and a characteristic of the product from the product number.

10. The method of claim 9 wherein filtering comprises identifying an enclosure capable of use based on the number, types, and characteristic and identifying an image corresponding to the enclosure, and wherein outputting comprises outputting the image with an overlay representing the first modification.

11. The method of claim 1 wherein outputting comprises outputting the specification document with dimensions and an image reflecting the modification.

12. The method of claim 1 wherein the product number corresponds to a base product with a first size, wherein the modification corresponds to a change to the product resulting in a second size different than the first size, and wherein populating with the second data comprises using the second size in the specification document.

13. In a non-transitory computer readable storage medium having stored therein data representing instructions executable by a programmed processor for generating a specification document of a product, the storage medium comprising instructions for:
identifying the product from a product number;
identifying a modification from a modification code;
selecting an enclosure as a function of both the product and the modification; and
generating the specification document with a dimension value represented in the specification document, the dimension value being a function of the enclosure, and with an image of the product including the modification.

14. The non-transitory computer readable storage medium of claim 13 wherein identifying the product comprises parsing the product number and determining a product class from a sub-part of the product number, and wherein selecting the enclosure comprises selecting the enclosure from a list of enclosures for the product class as a function of the modification.

15. The non-transitory computer readable storage medium of claim 13 wherein identifying the modification comprises identifying the modification and additional modifications of the product, and wherein selecting comprises selecting the enclosure as a function of a number of and types of the modifications and additional modifications, the enclosure capable of use with the number and types of the modification and additional modifications.

16. The non-transitory computer readable storage medium of claim 13 wherein generating comprises obtaining a base image of the enclosure and overlaying a representation of the modification on the base image, the image comprising the base image with the overlaid representation.

17. A method for generating a specification document, the method comprising:
receiving input of a product number;
receiving input of a modification;
altering, by a processor, an image of a product associated with the product number, the altering being based on the modification; and
outputting the specification document with the altered image.

18. The method of claim 17 wherein altering comprises overlaying a representation of the modification on the image.

19. The method of claim 17 further comprising determining an enclosure as a function of the product and the modification, and selecting the image for the enclosure.

20. The method of claim 17 further comprising populating a template with data based on the product number, data based on the modification, and a value based on both the modification and the product number.
